(19) United States
(12) Patent Application Publication
(10) Pub. No.: US 2025/0332841 A1
(43) Pub. Date: Oct. 30, 2025

(54) IMAGE FORMING APPARATUS

(71) Applicant: Roland DG Corporation, Hamamatsu-shi (JP)

(72) Inventors: Takayoshi OGURI, Hamamatsu-shi (JP); Kikuo MATSUBA, Hamamatsu-shi (JP)

(21) Appl. No.: 19/264,914

(22) Filed: Jul. 10, 2025

Related U.S. Application Data
(63) Continuation of application No. PCT/JP2023/002177, filed on Jan. 25, 2023.

(51) Int. Cl. B41J 2/175; B41J 29/377

(52) U.S. Cl. CPC B41J 2/17556; B41J 29/377

(57) ABSTRACT

An image forming apparatus includes an ink head including nozzles to discharge ink onto a medium, a heat sink on an upper surface of the ink head, and dampers directly above the ink head with the heat sink interposed therebetween. The ink head is movable in a direction in which printing is performed on the medium. The heat sink is configured to dissipate heat transferred from the ink head into the atmosphere. The dampers are integrated with the ink head and are configured to store the ink to be supplied to the ink head.

### CROSS REFERENCE TO RELATED APPLICATIONS

This application is a Continuation Application of PCT Application No. PCT/JP2023/002177 filed on Jan. 25, 2023. The entire contents of this application are hereby incorporated herein by reference.

### BACKGROUND OF THE INVENTION

### 1. Field of the Invention

The present invention relates to improved techniques for image forming apparatuses.

### 2. Description of the Related Art

Dampers are provided in a printer, a facsimile machine, a copy machine, and an image forming apparatus having a combination of functions thereof. The dampers are to reduce the pressure fluctuation of ink, which is supplied to an ink head from an ink supply line, to stabilize an operation for discharging ink from the ink head. There is a technique disclosed in, for example, Japanese Unexamined Patent Publication No. 2005-219229 (see FIG. 8 of Japanese Unexamined Patent Publication No. 2005-219229) as the related art relating to such an image forming apparatus.

In an image forming apparatus disclosed in Japanese Unexamined Patent Publication No. 2005-219229, a flat plate-shaped control board is overlaid on and joined to the upper surface of an ink head (recording head) and a plurality of dampers (pressure control valve unit) are overlaid on the upper surface of the control board. The respective dampers are positioned in a line in a movement direction of the ink head (main scanning direction), and are mounted on the ink head. Ink outlets of the respective dampers are directly joined to ink inlets of the ink head. Each of ink flow channels extending from the ink outlets of the respective dampers to the ink inlets of the ink head is vertical. For this reason, the lengths of the respective ink flow channels can be shortened and can be set to be substantially uniform.

### SUMMARY OF THE INVENTION

However, the image forming apparatus disclosed in Japanese Unexamined Patent Publication No. 2005-219229 does not include a heat sink for cooling a control circuit provided in the ink head. The control circuit is to control ink discharge nozzles of the ink head, and generates heat. It is preferable that a heat sink for dissipating heat is provided to stably operate the control circuit.

From the viewpoint of heat dissipation, the heat sink is required to be provided on the ink head. Some measures are required to provide both the heat sink and the dampers on the ink head. In order to cool the control circuit, the heat sink is preferentially provided on the ink head. In this case, it is conceivable that the positions of the dampers are shifted from the heat sink in the movement direction of the ink head.

However, a length in which the plurality of dampers are arranged should be greater than the length of the ink head in the movement direction (the length of the ink head). As a result, there is a large difference between the lengths of the respective ink flow channels extending from the ink outlets of the respective dampers to the ink inlets of the ink head. From the viewpoint of the ink discharge stability of the ink head, it is preferable that the lengths of portions of the ink flow channels extending, particularly, in the movement direction of the ink head (the horizontal lengths of portions of the flow channels long in a head movement direction) are short.

The reason for this is that dynamic pressure when ink present in the portions of the ink flow channels long in the head movement direction (residual ink) flows to the ink head is likely to fluctuate due to the influence of inertia associated with the movement of the ink as the ink head moves. For example, in a case where a large force in a reverse direction acts on the residual ink when the ink head discharges ink while moving, the internal pressure of the ink head is reduced. As a result, there is a possibility that ink may be discharged from the nozzles of the ink head at a low speed. On the other hand, in a case where a large force in the movement direction of the ink head acts on the residual ink, the internal pressure of the ink head is increased. As a result, the amount of ink discharged from the nozzles of the ink head may be increased.

Accordingly, from the viewpoint of the ink discharge stability of the ink head, the internal pressure of the ink head is required to be set to a more appropriate constant pressure.

Example embodiments of the present invention provide techniques that allow an internal pressure of an ink head of an image forming apparatus in which a heat sink is provided on the ink head to be set to a more appropriate constant pressure.

An image forming apparatus according to an example embodiment of the present invention includes an ink head that includes nozzles to discharge ink onto a medium and is movable in a direction in which printing is performed on the medium, a heat sink on an upper surface of the ink head and configured to dissipate heat transferred from the ink head into the atmosphere, and a damper that directly above the ink head with the heat sink interposed therebetween, integrated with the ink head, and configured to store the ink to be supplied to the ink head. In example embodiments of the present invention, it is possible to set the internal pressure of an ink head of an image forming apparatus in which a heat sink is provided on the ink head to a more appropriate constant pressure.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view of an image forming apparatus according to an example embodiment of the present invention.

FIG. 2 is a schematic diagram of a carriage shown in FIG. 1 and an ink supply system.

FIG. 3A is a schematic diagram of the ink supply system shown in FIG. 2 and FIG. 3B is a diagram viewed in a direction of an arrow 3B in FIG. 3A.

FIG. 4 is a perspective view of an ink discharge unit shown in FIG. 2.

FIG. 5 is an exploded perspective view of the ink discharge unit shown in FIG. 4.

FIG. 6 is a perspective view of a configuration in which a base plate, a heat sink, and a stand shown in FIG. 5 and a cooling fan are assembled.

FIG. 7 is a vertical sectional view of the ink discharge unit shown in FIG. 4.

FIG. 8 is a perspective view of an adapter shown in FIG. 5.

FIG. 9 is a perspective view of the adapter showing a cross-section taken along line 9-9 in FIG. 8.

FIG. 10 is a perspective view of a first damper shown in FIG. 4.

FIG. 11 is a sectional view taken along line 11-11 in FIG. 10.

FIG. 12 is an enlarged view of a portion 12 in FIG. 7.

### DETAILED DESCRIPTION OF THE EXAMPLE EMBODIMENTS

Example embodiments of the present invention will be described below with reference to the accompanying drawings. Meanwhile, the example embodiments shown in the accompanying drawings are merely examples of the present invention, and the present invention is not limited to the example embodiments.

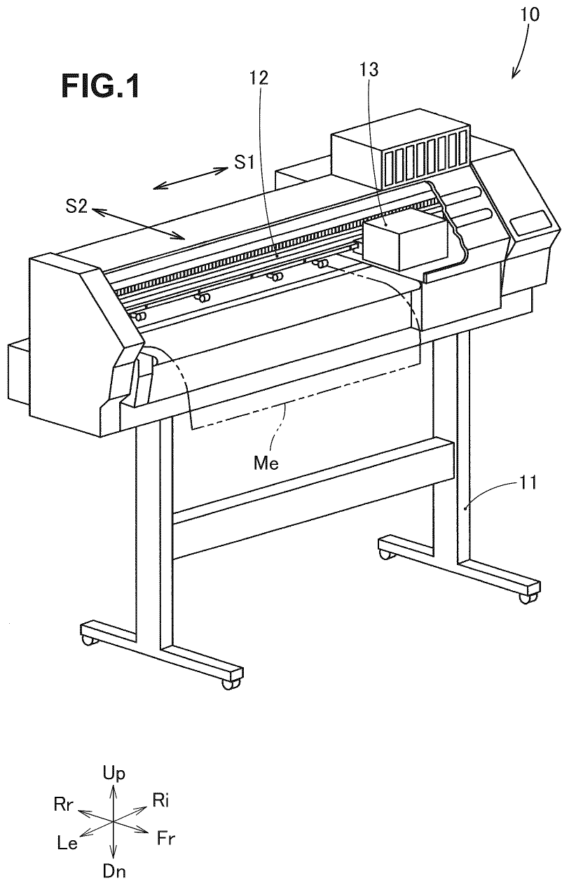

As shown in FIG. 1, an image forming apparatus 10 has a configuration of an inkjet printer that can form a color image on a medium Me. The image forming apparatus 10 can print, for example, large-sized signs and large-sized posters.

The medium Me as an object to be printed is, for example, a roll medium that is wound on a roll. A material of the medium Me can be made of, for example, various materials including paper such as plain paper, resins such as a polyvinyl chloride resin and a polyester resin, and metals such as an aluminum material and an iron material.

In the description, a left side, a right side, an upper side, and a lower side mean a left side, a right side, an upper side, and a lower side as viewed from a worker in front of the image forming apparatus 10, respectively. Further, in a case where a worker faces the front of the image forming apparatus 10, a direction toward the worker from a rear portion of the image forming apparatus 10 is defined as a forward direction and a direction from the worker toward the rear portion of the image forming apparatus 10 is defined as a rearward direction. In the drawings, Fr indicates the front side, Rr indicates the rear side, Le indicates the left side, Ri indicates the right side, Up indicates the upper side, and Dn indicates the lower side.

In a case where the rear side Rr of the image forming apparatus 10 is referred to as an upstream side, the front side Fr of the image forming apparatus 10 is referred to as a downstream side, the medium Me is transported from the upstream side toward the downstream side.

The image forming apparatus 10 includes a rail 12 that extends toward the left side Le and the right side Ri of a base 11 and a carriage 13 that is provided on the rail 12 to be movable to the left side Le and the right side Ri.

In a case where the image forming apparatus 10 is viewed from directly above, a movement direction S1 of the carriage 13 is referred to as “main scanning direction S1” and a transport direction S2 of the medium Me is referred to as “sub-scanning direction S2”. Here, the main scanning direction S1 corresponds to the left side Le and the right side Ri, and the sub-scanning direction S2 corresponds to the front side Fr and the rear side Rr. The main scanning direction S1 and the sub-scanning direction S2 are orthogonal to each other.

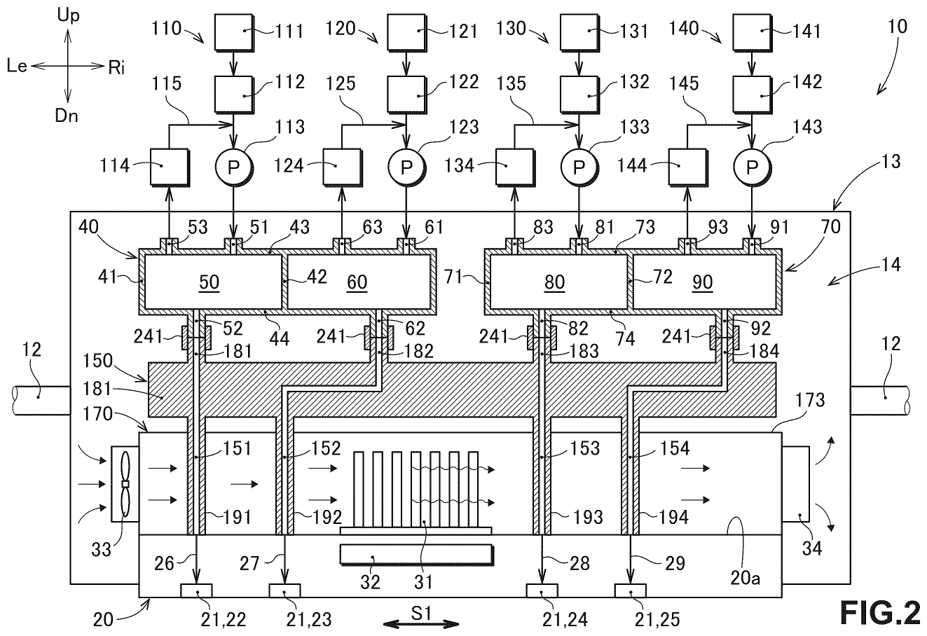

As shown in FIG. 2, the carriage 13 includes a plurality of sets of ink discharge units 14. Meanwhile, FIG. 2 shows only one set of ink discharge units 14. As the carriage 13 is moved in the main scanning direction S1, the ink discharge units 14 are moved in the main scanning direction S1 together with the carriage 13.

The ink discharge unit 14 includes one ink head 20 that can discharge ink, at least one heat sink 31 that can cool the ink head 20, one cooling fan 33 that sends cooling air to the heat sink 31, a plurality of (for example, two) dampers 40 and 70, and one adapter 150.

As the ink discharge unit 14 is moved in the main scanning direction S1 together with the carriage 13, the ink head 20 is movable in a direction S1 (main scanning direction S1) in which printing is performed on the medium Me (see FIG. 1). The ink head 20 includes a plurality of nozzles 21 that can discharge various ink droplets onto the medium Me. These nozzles 21 are arranged in the main scanning direction S1, and are also arranged in the sub-scanning direction S2 (see FIG. 1). The plurality of nozzles 21 are grouped into four nozzle groups 22 to 25 aligned in the main scanning direction S1. These nozzle groups 22 to 25 are positioned in a line, for example, from one side toward the other side in the main scanning direction S1.

In addition, the ink head 20 includes four ink inlets 26 to 29 on an upper surface 20a thereof. The four ink inlets 26 to 29 are positioned in a line, for example, from one side toward the other side in the main scanning direction S1. The first ink inlet 26 can supply ink, which has flowed in, to the first nozzle group 22. The second ink inlet 27 can supply ink, which has flowed in, to the second nozzle group 23. The third ink inlet 28 can supply ink, which has flowed in, to the third nozzle group 24. The fourth ink inlet 29 can supply ink, which has flowed in, to the fourth nozzle group 25.

The image forming apparatus 10 having such a configuration performs printing on the medium Me by moving the carriage 13 in the main scanning direction S1 and discharging ink droplets from the nozzles 21 of the ink head 20 while moving the medium Me in the sub-scanning direction S2 with a paper feeder, on the basis of image data.

In addition, a control circuit 32 to control each nozzle 21 is built in the ink head 20. An area around each nozzle 21 is heated by a heater (not shown). Heat generated by the control circuit 32 and the heater is transferred to the ink head 20.

The heat sink 31 is to prevent the control circuit 32 and the heater from overheating, and is configured to dissipate heat transferred from the ink head 20 into the atmosphere.

The cooling fan 33 is positioned relative to the heat sink 31 in the main scanning direction S1 in which the ink head 20 is movable. Cooling air sent from the cooling fan 33 flows in the main scanning direction S1, and is discharged into the atmosphere from an air discharge port 34 while cooling the heat sink 31.

Each of the dampers 40 and 70 is to reduce the pressure fluctuation of ink to be supplied to each nozzle 21 to stabilize an ink discharge operation of each nozzle 21. The two dampers 40 and 70 correspond to the four nozzle groups 22 to 25. One damper 40 of the two dampers 40 and 70 is referred to as “first damper 40”, and the other damper 70 is referred to as “second damper 70”.

The first damper 40 includes a first damper body 41. Two storage chambers 50 and 60 are provided in the first damper body 41. That is, the first damper body 41 includes two storage chambers 50 and 60 (a first storage chamber 50 and a second storage chamber 60) that are provided in a case where the inside of the first damper body 41 is partitioned into two spaces in the main scanning direction S1 by a vertical plate-shaped first partition wall 42.

The first storage chamber 50 communicates with a first ink inlet 51, a first ink outlet 52, and a first return port 53. The first ink inlet 51 and the first return port 53 are provided on a top board 43 of the first damper body 41. The first ink outlet 52 is provided on a bottom board 44 of the first damper body 41.

The second storage chamber 60 communicates with a second ink inlet 61, a second ink outlet 62, and a second return port 63. The second ink inlet 61 and the second return port 63 are provided on the top board 43 of the first damper body 41. The second ink outlet 62 is provided on the bottom board 44 of the first damper body 41.

The second damper 70 includes a second damper body 71. Two storage chambers 80 and 90 are provided in the second damper body 71. That is, the second damper body 71 includes two storage chambers 80 and 90 (a third storage chamber 80 and a fourth storage chamber 90) that are provided in a case where the inside of the second damper body 71 is partitioned into two spaces in the main scanning direction S1 by a vertical plate-shaped second partition wall 72.

The third storage chamber 80 communicates with a third ink inlet 81, a third ink outlet 82, and a third return port 83. The third ink inlet 81 and the third return port 83 are provided on a top board 73 of the second damper body 71. The third ink outlet 82 is provided on a bottom board 74 of the second damper body 71.

The fourth storage chamber 90 communicates with a fourth ink inlet 91, a fourth ink outlet 92, and a fourth return port 93. The fourth ink inlet 91 and the fourth return port 93 are provided on the top board 73 of the second damper body 71. The fourth ink outlet 92 is provided on the bottom board 74 of the second damper body 71.

Ink is supplied to each nozzle 21 of the first nozzle group 22 from a first ink supply system 110. The first ink supply system 110 can supply ink, which is stored in a first ink tank 111, to each nozzle 21 of the first nozzle group 22 from the first ink inlet 26 of the ink head 20 via a path including a first supply control valve 112, a first supply pump 113, and the first storage chamber 50 (including the first ink inlet 51 and the first ink outlet 52).

Ink stored in the first storage chamber 50 can return to a suction port of the first supply pump 113 from the first return port 53 via a first return control valve 114 and a first circulation path 115. In a case where a pigment having a high specific gravity is contained in the ink, it is possible to prevent the sedimentation of the pigment in the first storage chamber 50 by circulating the ink, which is stored in the first storage chamber 50, via the first circulation path 115.

Ink is supplied to each nozzle 21 of the second nozzle group 23 from a second ink supply system 120. The second ink supply system 120 can supply ink, which is stored in a second ink tank 121, to each nozzle 21 of the second nozzle group 23 from the second ink inlet 27 of the ink head 20 via a path including a second supply control valve 122, a second supply pump 123, and the second storage chamber 60 (including the second ink inlet 61 and the second ink outlet 62). Ink stored in the second storage chamber 60 can return to a suction port of the second supply pump 123 from the second return port 63 via a second return control valve 124 and a second circulation path 125.

Ink is supplied to each nozzle 21 of the third nozzle group 24 from a third ink supply system 130. The third ink supply system 130 can supply ink, which is stored in a third ink tank 131, to each nozzle 21 of the third nozzle group 24 from the third ink inlet 28 of the ink head 20 via a path including a third supply control valve 132, a third supply pump 133, and the third storage chamber 80 (including the third ink inlet 81 and the third ink outlet 82). Ink stored in the third storage chamber 80 can return to a suction port of the third supply pump 133 from the third return port 83 via a third return control valve 134 and a third circulation path 135.

Ink is supplied to each nozzle 21 of the fourth nozzle group 25 from a fourth ink supply system 140. The fourth ink supply system 140 can supply ink, which is stored in a fourth ink tank 141, to each nozzle 21 of the fourth nozzle group 25 from the fourth ink inlet 29 of the ink head 20 via a path including a fourth supply control valve 142, a fourth supply pump 143, and the fourth storage chamber 90 (including the fourth ink inlet 91 and the fourth ink outlet 92). Ink stored in the fourth storage chamber 90 can return to a suction port of the fourth supply pump 143 from the fourth return port 93 via a fourth return control valve 144 and a fourth circulation path 145.

The adapter 150 is a so-called ink relay that adjusts the flow direction of the ink to be supplied to the ink head 20 from each of the dampers 40 and 70. The adapter 150 includes a plurality of ink flow channels 151 to 154 that supply ink to the respective ink inlets 26 to 29 of the ink head 20 from the ink outlets 52, 62, 82, and 92 of the respective dampers 40 and 70.

The plurality of ink flow channels 151 to 154 include a first ink flow channel 151, a second ink flow channel 152, a third ink flow channel 153, and a fourth ink flow channel 154. The first ink flow channel 151 connects the first ink outlet 52 of the first damper 40 and the first ink inlet 26 of the ink head 20. The second ink flow channel 152 connects the second ink outlet 62 of the first damper 40 and the second ink inlet 27 of the ink head 20. The third ink flow channel 153 connects the third ink outlet 82 of the second damper 70 and the third ink inlet 28 of the ink head 20. The fourth ink flow channel 154 connects the fourth ink outlet 92 of the second damper 70 and the fourth ink inlet 29 of the ink head 20.

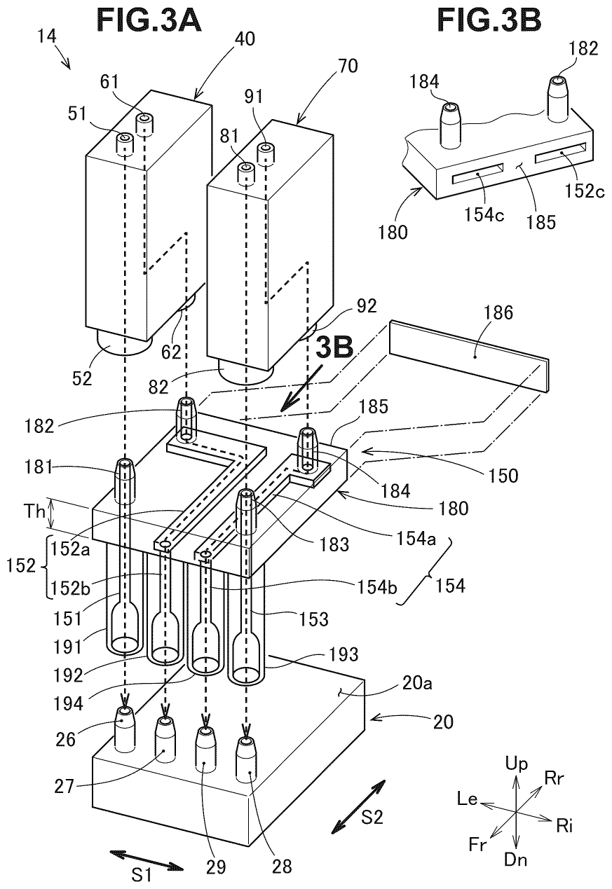

As shown in FIG. 3A, the four ink inlets 26 to 29 of the ink head 20 are positioned in a straight line from one side (left side Le) toward the other side (right side Ri) in the main scanning direction S1 in the order of the first ink inlet 26, the second ink inlet 27, the fourth ink inlet 29, and the third ink inlet 28. That is, the position of the third ink inlet 28 and the position of the fourth ink inlet 29 are arranged in reverse order. These ink inlets 26 to 29 are positioned at a portion of the ink head 20 corresponding to the front side Fr, and extend upward from the upper surface 20a of the ink head 20.

In contrast, the first damper 40 and the second damper 70 are positioned in a line from one side (left side Le) toward the other side (right side Ri) in the main scanning direction S1 in this order. The outer shape of each of the dampers 40 and 70 is the shape of a substantially rectangular parallelepiped that is thin and flat in the main scanning direction S1.

The first ink outlet t 52 of the first damper 40 is positioned directly above the first ink inlet 26 of the ink head 20. The second ink outlet 62 of the first damper 40 is positioned directly behind the first ink outlet 52.

The ink flow channels 151 to 154 of the adapter 150 will be described.

The first ink flow channel 151 extends vertically straight from the first ink outlet 52 of the first damper 40 to the first ink inlet 26 of the ink head 20. The second ink flow channel 152 includes a bypass channel 152a that bypasses the first ink outlet 52 of the first damper 40 only in the main scanning direction S1 (horizontal direction), and a vertical channel 152b that extends from a tip of the bypass channel 152a to the second ink inlet 27 of the ink head 20. The bypass channel 152a extends from the second ink outlet 62 of the first damper 40 to a position directly above the second ink inlet 27 of the ink head 20 while bypassing the first ink outlet 52 in the horizontal direction in an L shape as viewed in a plan view. The vertical channel 152b extends vertically straight from the bypass channel 152a to the second ink inlet 27.

The third ink outlet 82 of the second damper 70 is positioned directly above the fourth ink inlet 29 of the ink head 20. The fourth ink outlet 92 of the second damper 70 is positioned directly behind the third ink outlet 82.

The third ink flow channel 153 extends from the third ink outlet 82 of the second damper 70 to the third ink inlet 28 of the ink head 20. The fourth ink flow channel 154 includes a bypass channel 154a that bypasses the third ink outlet 82 of the second damper 70 only in the main scanning direction S1 (horizontal direction), and a vertical channel 154b that extends from a tip of the bypass channel 154a to the fourth ink inlet 29 of the ink head 20. The bypass channel 154a extends from the fourth ink outlet 92 of the second damper 70 to a position directly above the fourth ink inlet 29 of the ink head 20 while bypassing the third ink outlet 82 in the horizontal direction in an L shape as viewed in a plan view. The vertical channel 154b extends vertically straight from the bypass channel 154a to the fourth ink inlet 29.

The bypass channel 152a of the second ink flow channel 152 and the bypass channel 154a of the fourth ink flow channel 154 are close to each other as viewed in a plan view.

As described above, the arrangement of the ink inlets 26 to 29 of the ink head 20 relative to the arrangement of the ink outlets 52, 62, 82, and 92 of the respective dampers 40 and 70 is set in the image forming apparatus 10 according to the present example embodiment such that the ink flow channels 151 to 154 of the adapter 150 do not cross each other in a vertical direction.

In addition, in the image forming apparatus 10 according to the present example embodiment, one or more ink flow channels 151 and 153 (first and third ink flow channels 151 and 153) of the plurality of ink flow channels 151 to 154 are positioned in a straight line in the vertical direction from the ink outlets 52 and 82 of the dampers 40 and 70 to the ink inlets 26 and 28 of the ink head 20.

All the ink flow channels 151 to 154 do not cross each other in the vertical direction, and at least one of the plurality of ink flow channels 151 to 154 is positioned in a straight line. For this reason, the lengths of the ink flow channels 151 to 154 can be made as short as possible.

Meanwhile, since the first and second dampers 40 and 70 are close to each other in the main scanning direction S1, the first ink outlet 52 of the first damper 40 can also be positioned directly above the second ink inlet 27 of the ink head 20 and the third ink outlet 82 of the second damper 70 can also be positioned directly above the fourth ink inlet 29 of the ink head 20.

The volumes of all the ink flow channels 151 to 154 are set to be the same. For example, the diameters of the second and fourth ink flow channels 152 and 154 are set to be larger than the diameters of the first and third ink flow channels 151 and 153. Accordingly, the pressure resistances (pressure losses) of inks passing through all the ink flow channels 151 to 154 can be set to be the same. Meanwhile, the inks passing through the respective ink flow channels 151 to 154 have substantially the same viscosity.

The lengths of portions of the ink flow channels 151 to 154 extending, particularly, in the movement direction of the ink head 20, that is, the main scanning direction S1 (the horizontal lengths of portions of the flow channels long in a head movement direction) are short. For example, as shown in FIG. 3A, the first and third ink flow channels 151 and 153 are vertical. A portion of the bypass channel 152a of the second ink flow channel 152 extending in the main scanning direction S1 is short since merely bypassing the first ink flow channel 151 as viewed in a plan view. A portion of the bypass channel 154a of the fourth ink flow channel 154 extending in the main scanning direction S1 is short since merely bypassing the third ink flow channel 153 as viewed in a plan view. For this reason, the internal pressure of the ink head can be set to a more appropriate constant pressure.

Hereinafter, the image forming apparatus 10 will be described in more detail.

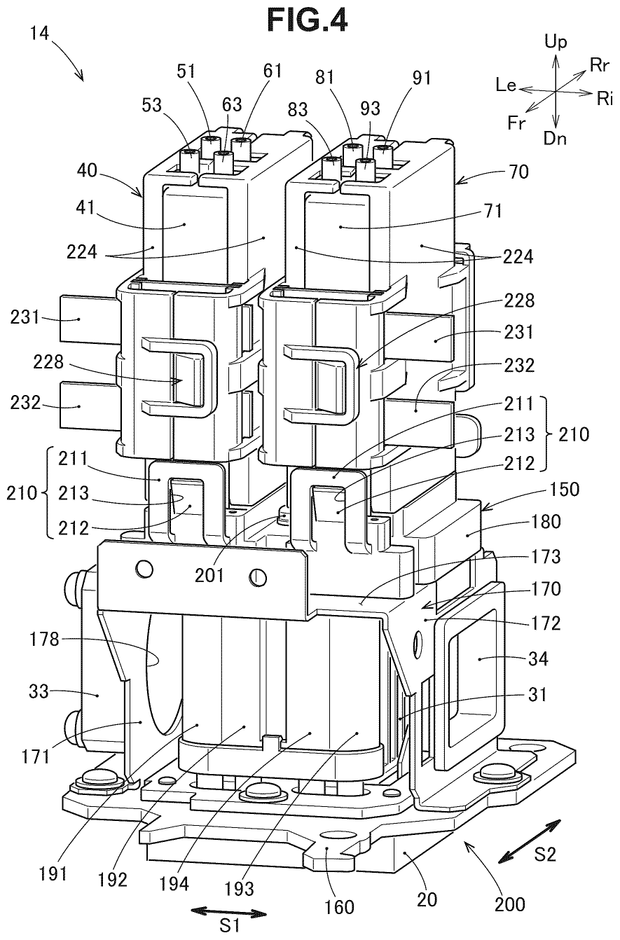

As shown in FIG. 4 to FIG. 7, the ink head 20 is detachably mounted on a base plate 160. The base plate 160 is a flat plate-shaped structure that can be mounted on the carriage 13, and includes a through-hole 161 into which the ink head 20 can be fitted from above.

A stand 170 is mounted on an upper surface of the base plate 160. The stand 170 includes a pair of vertical plate-shaped wall plates 171 and 172 (a first wall plate 171 and a second wall plate 172) that stands up from both ends of the base plate 160 in the main scanning direction S1, and a flat plate-shaped top board 173 that connects upper ends of these wall plates 171 and 172. An opening 174, which is on one side (rear side Rr) of the stand 170 in the sub-scanning direction S2, is covered with a plate-shaped structure 175, such as a control board. An opening 176, which is on the other side (front side Fr) of the stand 170 in the sub-scanning direction S2, is covered with a plurality of vertical pipes 191 to 194 included in the adapter 150. The top board 173 includes a through-hole 177 through which the pipes 191 to 194 of the adapter 150 can pass. Meanwhile, a configuration in which the inside of the base plate 160 is surrounded by only the base plate 160 may be adopted.

The heat sink 31 is provided in the stand 170. The first wall plate 171 provided on the left side Le is provided with an air guide port 178, and the cooling fan 33 is mounted on the first wall plate 171. The second wall plate 172 provided on the right side Ri is provided with an air discharge port 34. Cooling air sent by the cooling fan 33 is discharged into the atmosphere from the air discharge port 34 while cooling the heat sink 31 through the air guide port 178. As described above, the stand 170 serves as a duct to allow cooling air, which is sent by the cooling fan 33, to flow in the main scanning direction S1.

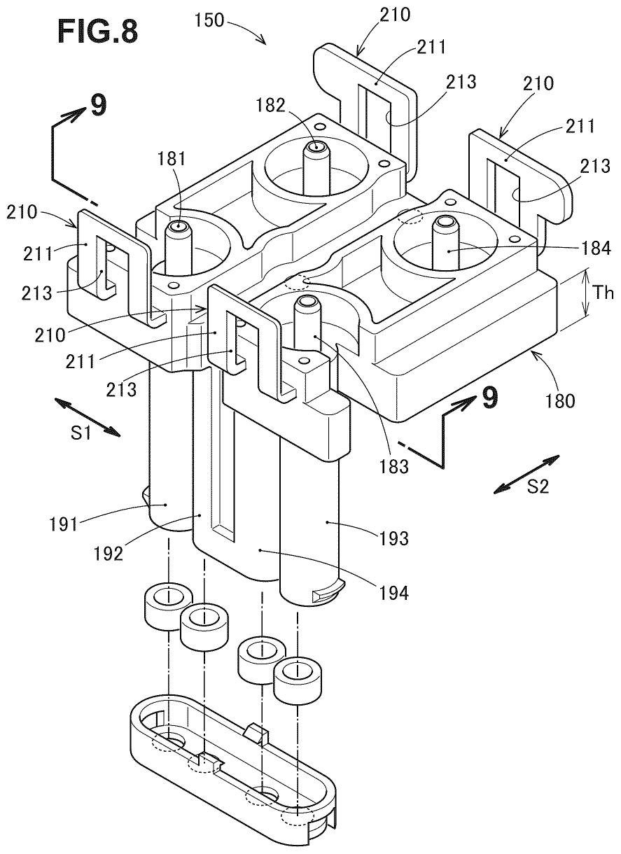

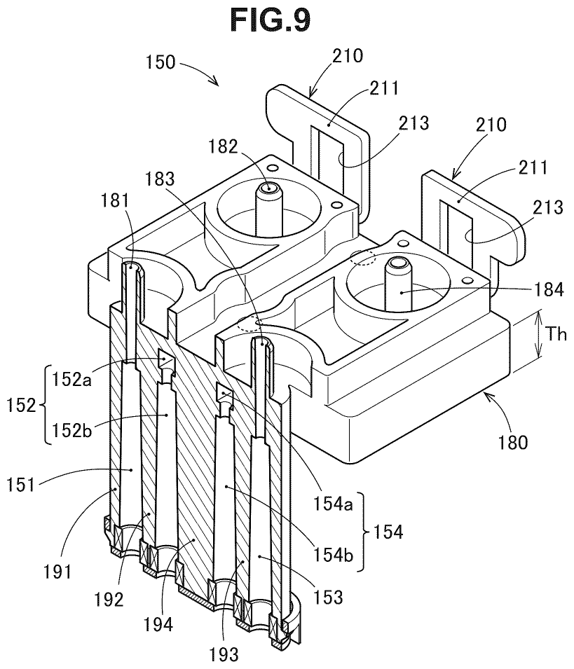

As shown in FIG. 8 and FIG. 9, the adapter 150 is a resin molded product that includes a flat plate-shaped adapter body 180 (first structure 180) and four pipes 191 to 194 (second structures 191 to 194) extending downward from the adapter body 180.

The adapter body 180 includes an inlet portion 181 of the first ink flow channel 151, an inlet portion 182 of the second ink flow channel 152, an inlet portion 183 of the third ink flow channel 153, and an inlet portion 184 of the fourth ink flow channel 154 that extend upward from an upper surface thereof. The inlet portion 181 of the first ink flow channel 151 faces the first ink outlet 52 of the first damper 40 shown in FIG. 2. The inlet portion 182 of the second ink flow channel 152 faces the second ink outlet 62 of the first damper 40 shown in FIG. 2. The inlet portion 183 of the third ink flow channel 153 faces the third ink outlet 82 of the second damper 70 shown in FIG. 2. The inlet portion 184 of the fourth ink flow channel 154 faces the fourth ink outlet 92 of the second damper 70 shown in FIG. 2.

In addition, the adapter body 180 includes the bypass channel 152a of the second ink flow channel 152 and the bypass channel 154a of the fourth ink flow channel 154. For this reason, in a case where the adapter 150 is viewed from above as shown in FIG. 3A, all the ink flow channels 151 to 154 do not overlap with each other. Accordingly, the thickness Th (see FIG. 3A) of the flat plate-shaped adapter body 180 can be set to be small.

Moreover, as shown in FIGS. 3A and 3B, the respective bypass channels 152a and 154a have an L shape in a plan view. For this reason, in a case where the bypass channels 152a and 154a are provided in the adapter body 180 made of a resin from a side surface 185, a single sheet 186 for a seal can be merely joined to the side surface 185 to close openings 152c and 154c (see FIG. 3B) of the bypass channels 152a and 154a. The sheet 186 for a seal can be made of, for example, a film for heat sealing.

The four pipes 191 to 194 are a first pipe 191 including the first ink flow channel 151, a second pipe 192 including the vertical channel 152b of the second ink flow channel 152, a third pipe 193 including the third ink flow channel 153, and a fourth pipe 194 including the vertical channel 154b of the fourth ink flow channel 154.

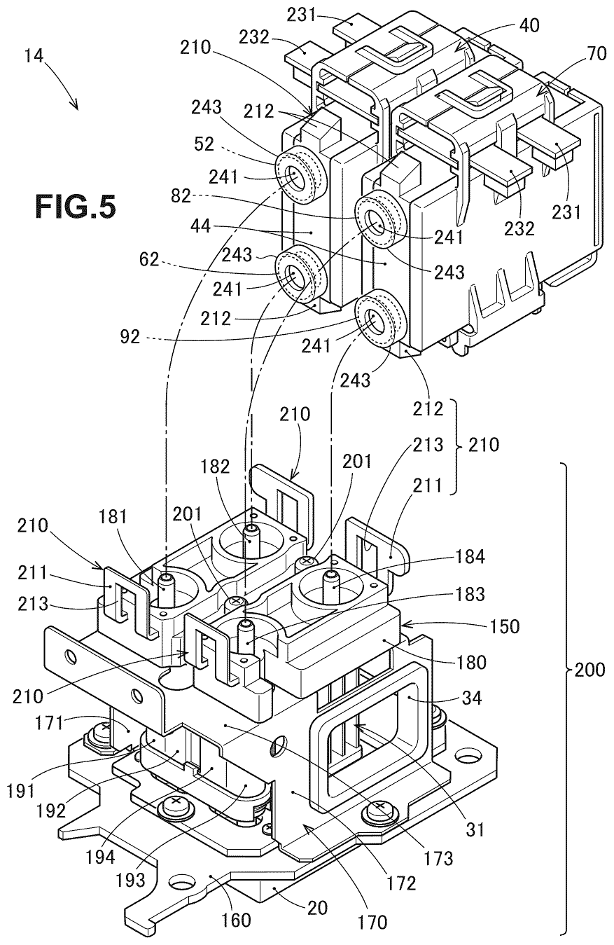

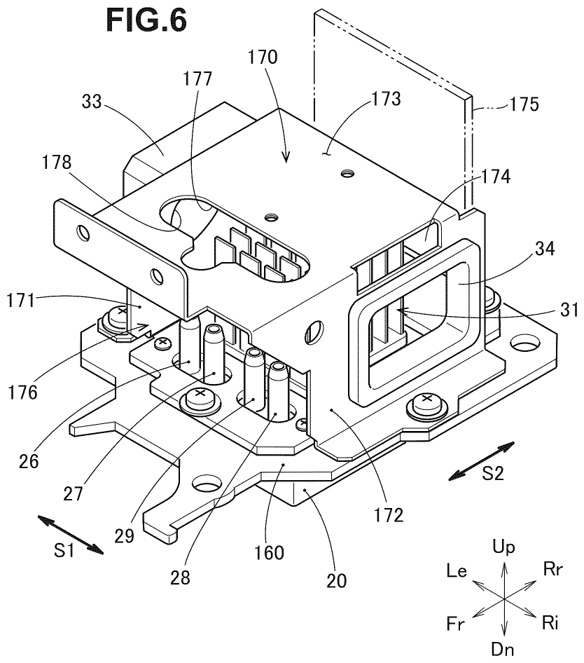

Also referring to FIG. 5 and FIG. 6, the adapter body 180 is provided on the top board 173 of the stand 170 and is mounted on the top board 173 by screws 201. Accordingly, the adapter 150 is positioned directly above the heat sink 31, and is detachably attached to the stand 170. As a result, as shown in FIG. 5, the head unit 200 (so-called sub-assembly 200) in which the ink head 20, the stand 170, the heat sink 31, the cooling fan 33, and the adapter 150 are integrated with the base plate 160 is provided. As described above, the stand 170 serves as an attachment base to which the adapter 150 is attached in addition to a duct to allow cooling air to flow.

As clear from the above description, the heat sink 31 is provided on the upper surface 20a of the ink head 20. The adapter 150 is positioned directly above the heat sink 31. In addition, also referring to FIG. 4 and FIG. 5, the first and second dampers 40 and 70 are positioned directly above the adapter 150. Accordingly, the first and second dampers 40 and 70 are positioned directly above the heat sink 31. As a result, the first and second dampers 40 and 70 are positioned directly above the ink head 20 with the heat sink 31 interposed therebetween.

As shown in FIG. 4, FIG. 5, and FIG. 8, the first and second dampers 40 and 70 are detachably provided on the adapter 150. For example, the first and second dampers 40 and 70 are detachably fixed to the adapter 150 by a plurality of latch mechanisms 210. The respective latch mechanisms 210 include, for example, a plurality of latch arms 211 provided on the adapter 150 and a plurality of latch claws 212 provided on the first and second dampers 40 and 70.

Specifically, the adapter body 180 is integrally provided with four latch arms 211 each including a latch hole 213. Each latch arm 211 includes an elastic piece that stands up from an edge of the adapter body 180. The respective damper bodies 41 and 71 of the first and second dampers 40 and 70 are integrally provided with the four latch claws 212. The latch claw 212 is caught by the latch hole 213, so that the latch claw 212 and the latch hole 213 can latch on each other.

The first and second dampers 40 and 70 are attached to the adapter 150 by the latch mechanisms 210, so that the first and second dampers 40 and 70 can be integrated with the head unit 200. As a result, the integrated ink discharge unit 14 (see FIG. 4) can be provided. Therefore, it is easy to incorporate the plurality of ink discharge units 14 into the carriage 13 (see FIG. 2). Moreover, since it is possible to detach the first and second dampers 40 and 70 from the head unit 200 by merely releasing the latch mechanisms 210, it is easy to perform maintenance work for the first and second dampers 40 and 70.

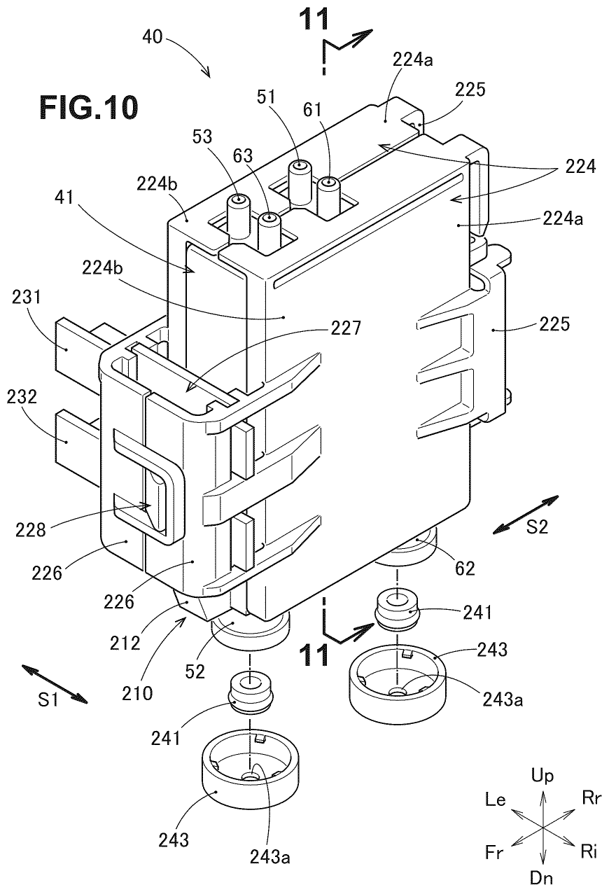

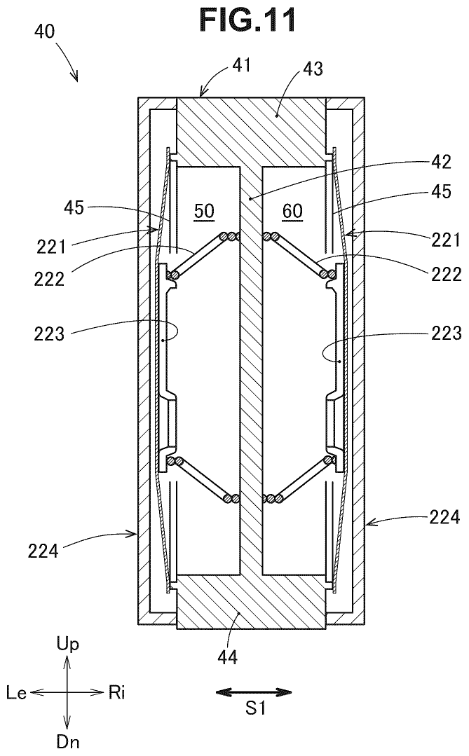

Next, the first damper 40 will be described with reference to FIG. 5, FIG. 10, and FIG. 11. Since the second damper 70 has the same configuration as the first damper 40, the description thereof will be omitted.

As shown in FIG. 11, the two storage chambers 50 and 60 (the first storage chamber 50 and the second storage chamber 60) of the first damper 40 are spaces separated from each other and independent of each other, and sides of the storage chambers 50 and 60 opposite to each other are open. That is, the first damper body 41 includes openings 45 and 45 that are open over the entire surface on both surfaces thereof in the main scanning direction S1. These openings 45 and 45 are closed by damper films 221 and 221, respectively. As a result, the two storage chambers 50 and 60 are sealed.

The damper films 221 and 221 include sheets (including films) that are elastically deformable depending on the amount of ink stored in the storage chambers 50 and 60 or the pressures in the storage chambers 50 and 60, respectively. For example, it is preferable that the damper films 221 and 221 are made of a transparent or translucent resin material. The damper films 221 and 221 are mounted on the first damper body 41 with such a degree of tension that allows the damper films 221 and 221 to be bent to the inside and outside of the storage chambers 50 and 60, respectively.

Biasing structures 222 and 222 to bias each of the damper films 221 and 221 to the outside are interposed between a wall surface of the first partition wall 42 and a film surface (sheet surface) of each of the damper films 221 and 221. Each of these biasing structures 222 and 222 includes, for example, a compression coil spring. It is preferable that a pressing plate 223 is interposed between each of the damper films 221 and 221 and the biasing structures 222 and 222.

The damper films 221 and 221 are covered with two covers 224 and 224, respectively. Each of the covers 224 and 224 is made of a material such as a resin that is lightproof and opaque. These covers 224 and 224 can cover the damper films 221 and 221 from the outside of the first damper body 41 (sides opposite to the storage chambers 50 and 60) by closing the openings 45 and 45.

As shown in FIG. 10, side base end portions 224a of the respective covers 224 and 224 are supported on the first damper body 41 by hinge mechanisms 225 and 225 to be openable and closable in the main scanning direction S1. Open end portions 224b and 224b of the respective covers 224 and 224 are integrally provided with cover extension portions 226 and 226 facing each other. The cover extension portions 226 and 226 extend from the open end portions 224b and 224b of the covers 224 and 224 to sides opposite to the hinge mechanisms 225 and 225, respectively. For this reason, a space portion 227 is provided between the first damper body 41 and the respective cover extension portions 226 and 226. The cover extension portions 226 and 226 detachably latch on each other with a latch mechanism 228.

A first pressure detection unit 231 and a second pressure detection unit 232 are provided in the space portion 227. The first pressure detection unit 231 can detect the internal pressure of the first storage chamber 50. The second pressure detection unit 232 can detect the internal pressure of the second storage chamber 60.

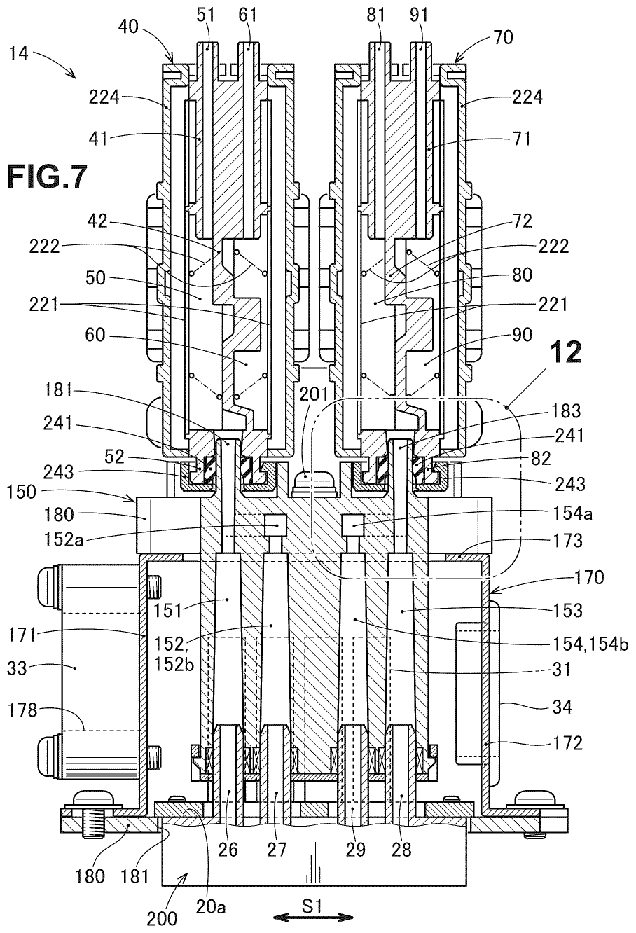

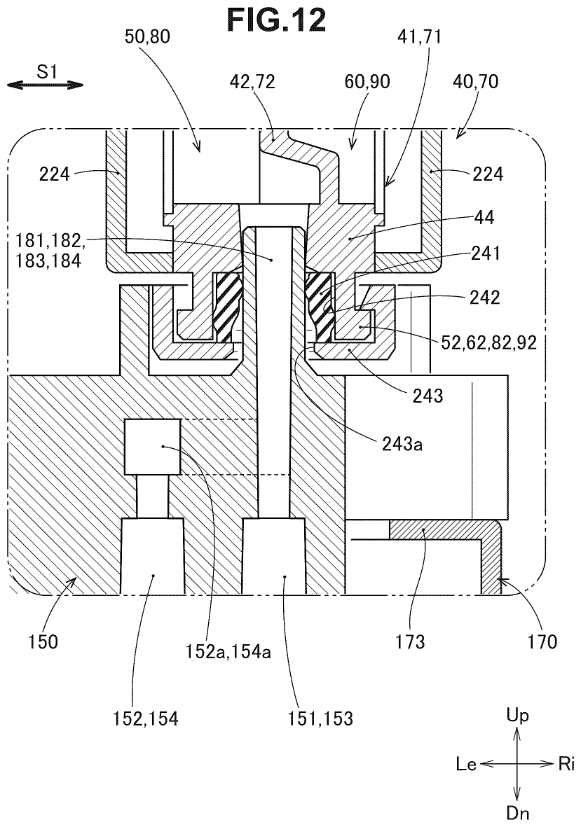

As shown in FIG. 5, FIG. 7, and FIG. 12, spaces between the ink outlets 52, 62, 82, and 92 of the respective dampers 40 and 70 and the inlet portions 181 to 184 of the respective ink flow channels 151 to 154 of the adapter 150 are sealed by seals 241. The seals 241 are mounted on the dampers 40 and 70.

Specifically, as shown in FIG. 12, the ink outlets 52, 62, 82, and 92 are cylindrical portions that extend from the bottom boards 44 and 74 of the damper bodies 41 and 71 toward the inlet portions 181 to 184 of the ink flow channels 151 to 154 of the adapter 150. An inner peripheral portion of a tip of each of the ink outlets 52, 62, 82, and 92 includes an annular recess 242. The seal 241 is an annular rubber product, and is fitted into the recess 242. A cap 243 is detachably mounted on the tip of each of the ink outlets 52, 62, 82, and 92 by latching. The cap 243 prevents the seal 241, which is fitted into the recess 242, from falling off. As a result, the seals 241 are mounted on the dampers 40 and 70.

In addition, the cap 243 includes a through-hole 243a at the center thereof. The inlet portion 181 of the first ink flow channel 151 of the adapter 150 has a tubular configuration, penetrates the through-hole 243a of the cap 243 and the seal 241, and extends into the ink outlets 52. The seal 241 includes seal portions that are convex over the entire circumference on an inner peripheral surface and an outer peripheral surface thereof, and seals a space between the inner peripheral surface of the recess 242 and the outer peripheral surface of the inlet portion 181 of the first ink flow channel 151 in a liquid-tight manner.

In general, the dampers 40 and 70 (first and second dampers 40 and 70) are more inexpensive than the ink head 20. The adapter 150 is incorporated into the ink head 20. In a case where malfunction occurs in the dampers 40 and 70, it is preferable in terms of ensuring liquid-tightness that the seals 241 are also replaced with new seals with the replacement of the malfunctioning dampers 40 and 70.

In the present example embodiment, the seals 241 are mounted on the dampers 40 and 70. For this reason, it is also possible to replace the seals 241 with new seals by merely replacing the malfunctioning dampers 40 and 70. Accordingly, it is possible to reduce replacement costs for the seals 241 as compared to a case where the seals 241 are mounted on the adapter 150 incorporated into the ink head 20. Moreover, it is possible to sufficiently ensure the air-tightness and liquid-tightness of the seal 241.

The above description is summarized as follows.

As shown in FIG. 2, FIG. 3A, and FIG. 7, the image forming apparatus 10 includes the ink head 20 that includes the nozzles 21 capable of discharging ink onto the medium Me and is movable in the direction S1 (main scanning direction S1) in which printing is performed on the medium Me, the heat sink 31 that is provided on the upper surface 20a of the ink head 20, and the dampers 40 and 70 (first and second dampers 40 and 70) that are positioned directly above the ink head 20 with the heat sink 31 interposed therebetween and are integrated with the ink head 20. The heat sink 31 can dissipate heat transferred from the ink head 20 into the atmosphere. The dampers 40 and 70 can store ink to be supplied to the ink head 20.

As described above, the dampers 40 and 70 are positioned directly above the ink head 20 with the heat sink 31 interposed therebetween and are integrated with the ink head 20. For this reason, each of the ink flow channels 151 to 154 between the ink outlets 52, 62, 82, and 92 of the respective dampers 40 and 70 and the ink inlets 26 to 29 of the ink head 20 can be made to extend in the vertical direction as much as possible. Accordingly, even though the heat sink 31 is provided, each of the ink flow channels 151 to 154 can be set to be as short as possible.

In particular, the lengths of portions of the ink flow channels 151 to 154 extending in the movement direction of the ink head 20, that is, the main scanning direction S1 (the horizontal lengths of portions of the flow channels long in the head movement direction) can be set to be as short as possible. For this reason, the fluctuation of dynamic pressure when ink present in the portions of the flow channels long in the head movement direction (residual ink) flows to the ink head can be set to be reduced as much as possible.

Accordingly, the internal pressure of the ink head 20 of the image forming apparatus 10 in which the heat sink 31 is provided on the ink head 20 can be set to a more appropriate constant pressure.

As shown in FIG. 3A, the image forming apparatus 10 further includes the adapter 150 that includes the plurality of ink flow channels 151 to 154 to supply ink to the ink inlets 26 to 29 of the ink head 20 from the ink outlets 52, 62, 82, and 92 of the dampers 40 and 70 (first and second dampers 40 and 70). One or more ink flow channels 151 and 153 of the plurality of ink flow channels 151 to 154 are positioned in a straight line from the ink outlets 52 and 82 of the dampers 40 and 70 to the ink inlets 26 and 28 of the ink head 20.

Since one or more ink flow channels 151 and 153 are positioned in a straight line, the lengths of the ink flow channels 151 and 153 can be further shortened. In addition, since, for example, the volumes of the respective ink flow channels 151 to 154 are set to be substantially the same, ink pressure applied from the ink flow channels 151 to 154 to the inside of the ink head 20 can be made uniform and reduced. For this reason, the internal pressure of the ink head 20 can be set to a more appropriate constant pressure.

As shown in FIG. 3A and FIG. 7 to FIG. 9, the adapter 150 includes the horizontal adapter body 180 (first structure 180) and the pipes 191 to 194 (second structures 191 to 194) that extend from the adapter body 180 in the vertical direction. The ink flow channels 151 and 153 positioned in a straight line are provided in the pipes 191 to 194.

For this reason, it is easy to perform positioning and fixing for the integration of a portion (ink discharge unit 14) from the dampers 40 and 70 up to the ink head 20 using the adapter 150.

As shown in FIG. 3A, the image forming apparatus 10 includes the adapter 150 that includes the plurality of ink flow channels 151 to 154 to supply ink to the ink inlets 26 to 29 of the ink head 20 from the ink outlets 52, 62, 82, and 92 of the dampers 40 and 70 (first and second dampers 40 and 70). The adapter 150 includes the plate-shaped adapter body 180 (first structure 180) of which a plate surface faces the vertical direction, and the pipes 191 to 194 (second structures 191 to 194) that extend downward from the adapter body 180.

The first structure 180 includes the plurality of inlet portions 181 to 184 that are provided on the upper surface thereof to be connected to the ink outlets 52, 62, 82, and 92 of the dampers 40 and 70. In a case where the first structure 180 is viewed from above and four corners of a rectangular shape are assumed, the plurality of inlet portions 181 to 184 are located at positions corresponding to the four corners. One or more of the plurality of inlet portions 181 to 184 are designated as “specific inlet portions 181 and 183”, the rest thereof are designated as “the other inlet portions 182 and 184”, the ink flow channels 151 and 153 (first and third ink flow channels 151 and 153) connected to the specific inlet portions 181 and 183 among the plurality of ink flow channels 151 to 154 are designated as “specific ink flow channels 151 and 153”, and the ink flow channels 152 and 154 (second and fourth ink flow channels 152 and 154) connected to the other inlet portions 182 and 184 are designated as “the other ink flow channels 152 and 154”.

The specific ink flow channels 151 and 153 are positioned in a straight line from the specific inlet portions 181 and 183 to the ink inlets 26 and 28 of the ink head 20, and pass through the insides of the second structures 191, 193. The other ink flow channels 152 and 154 include the horizontal flow channels 152a and 154a (bypass channels 152a and 154a) that horizontally pass through the inside of the first structure 180 from the other inlet portions 182 and 184, and the vertical flow channels 152b and 154b (vertical channels 152b and 154b) that are positioned in a straight line from the horizontal flow channels 152a and 154a to the ink inlets 27 and 29 of the ink head 20 and pass through the insides of the second structures 192, 194. The specific ink flow channels 151 and 153 and the vertical flow channels 152b and 154b are positioned in a line in the horizontal direction (main scanning direction S1).

Therefore, the lengths of the ink flow channels 151 to 154 can be shortened regardless of the positions of the ink inlets 26 to 29 of the ink head 20 and the positions of the ink outlets 52, 62, 82, and 92 of the dampers 40 and 70.

As shown in FIG. 2, FIG. 4, and FIG. 7, the heat sink 31 is positioned within a range in which the first structure 180 is present as the adapter 150 is viewed from above, that is, within the range of a projection image (vertical projection image) of the adapter 150 viewed from above. In addition, as shown in FIG. 4 and FIG. 5, the heat sink 31 is positioned next to the second structures 191 to 194.

For this reason, a portion (ink discharge unit 14) from the dampers 40 and 70 up to the ink head 20 can be more appropriately reduced in size and integrated. Accordingly, an increase in the size of the carriage 13 can be prevented.

As shown in FIG. 4, the image forming apparatus 10 further includes the cooling fan 33 that sends cooling air to the heat sink 31. The cooling fan 33 is positioned relative to the heat sink 31 in the main scanning direction S1 in which the ink head 20 is movable.

In a case where printing is performed on the medium Me (see FIG. 1), the heat sink 31 is moved together with the ink head 20 in the main scanning direction S1. In contrast, the cooling fan 33 sends cooling air in the movement direction S1 of the heat sink 31 (main scanning direction S1). That is, a blowing direction in which cooling air sent from the cooling fan 33 flows toward the heat sink 31 is the same as the movement direction S1 of the heat sink 31. For this reason, the heat sink 31 can be efficiently cooled by the cooling air.

The present invention is not limited to the example embodiments described above as long as the actions and effects of example embodiments of the present invention are achieved.

Image forming apparatuses according to example embodiments of the present invention are suitable as inkjet printers.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An image forming apparatus comprising:
an ink head that includes nozzles to discharge ink onto a medium and is movable in a direction in which printing is performed on the medium;
a heat sink on an upper surface of the ink head and configured to dissipate heat transferred from the ink head into the atmosphere; and
a damper that directly above the ink head with the heat sink interposed therebetween, integrated with the ink head, and configured to store the ink to be supplied to the ink head.

2. The image forming apparatus according to claim 1, further comprising:
an adapter that includes a plurality of ink flow channels to supply the ink to ink inlets of the ink head from ink outlets of the dampers; wherein
one or more ink flow channels of the plurality of ink flow channels are positioned in a straight line from the ink outlets of the dampers to the ink inlets of the ink head.

3. The image forming apparatus according to claim 2, wherein
the adapter includes a horizontal adapter body and a second structure extending from the first structure in a vertical direction; and
the ink flow channels positioned in a straight line are provided in the second structure.

4. The image forming apparatus according to claim 1, further comprising:
an adapter that includes a plurality of ink flow channels to supply the ink to ink inlets of the ink head from ink outlets of the dampers; wherein
the adapter includes a plate-shaped first structure of which a plate surface faces a vertical direction, and a second structure extending downward from the first structure;
the first structure includes a plurality of inlet portions that are provided on an upper surface thereof to be connected to the ink outlets of the damper;
in a case where the first structure is viewed from above and four corners of a rectangular shape are assumed, the plurality of inlet portions are at positions corresponding to the four corners; and
in a case where one or more of the plurality of inlet portions are designated as specific inlet portions, a remainder thereof are designated as other inlet portions, ink flow channels connected to the specific inlet portions among the plurality of ink flow channels are designated as specific ink flow channels, and ink flow channels connected to the other inlet portions are designated as the other ink flow channels, the specific ink flow channels are positioned in a straight line from the specific inlet portions to the ink inlets of the ink head and pass through the inside of the second structure, the other ink flow channels include horizontal flow channels that horizontally pass through the inside of the first structure from the other inlet portions and vertical flow channels that are positioned in a straight line from the horizontal flow channels to the ink inlets of the ink head and pass through the inside of the second structure, and the specific ink flow channels and the vertical flow channels are positioned in a line in a horizontal direction.

5. The image forming apparatus according to claim 3, wherein the heat sink is positioned within a range in which the first structure is present as the adapter is viewed from above, and is positioned next to the second structure.

6. The image forming apparatus according to claim 1, further comprising:
a cooling fan to send cooling air to the heat sink; wherein
the cooling fan is positioned relative to the heat sink in a main scanning direction in which the ink head is movable.
